(19) United States
(12) Patent Application Publication
(10) Pub. No.: US 2019/0086011 A1
(43) Pub. Date: Mar. 21, 2019

(54) PUSH-BUTTON QUICK-CONNECT COUPLER INCLUDING A PRESSURE GAUGE

(71) Applicant: Campbell Hausfeld, LLC, Harrison, OH (US)

(72) Inventors: Nicholas Steven Hafele, Cincinnati, OH (US); Rodney A. Ratz, Brookville, IN (US)

(21) Appl. No.: 16/136,087

(22) Filed: Sep. 19, 2018

Related U.S. Application Data
(60) Provisional application No. 62/560,436, filed on Sep. 19, 2017.

(51) Int. Cl. F16L 37/098; F16L 55/10; F16L 37/086

(52) U.S. Cl. CPC F16L 37/0982; F16L 55/1015; G01L 19/0007; F16L 37/086; F16L 37/0987

(57) ABSTRACT

A coupler includes a body, a stem, an actuator and a pressure gauge. The body defines an input port, an output port, a venting port and a main passageway. The stem is slidably coupled with the body and is slidable between a retracted position, a venting position, and an extended position. The venting position is between the retracted position and the extended position. The stem is biased into the retracted position. The actuator is operably coupled with the stem and is movable between a released position and an actuated position. The pressure gauge is coupled with the body and is in fluid communication with one of the input port and the output port. The pressure gauge is configured to detect and display a fluid pressure at said one of the input port and the output port

### REFERENCE TO RELATED APPLICATION

This application claims priority of U.S. provisional patent application Ser. No. 62/560,436, entitled Push-Button Quick-Connect Coupler Including a Pressure Gauge, filed Sep. 19, 2017, and hereby incorporates this provisional patent application by reference herein in its entirety.

### TECHNICAL FIELD

This application relates generally to a push-button quick-connect coupler that includes an integrated pressure gauge.

### BACKGROUND

Conventional push-button quick-connect couplers include a push-button which can be initially depressed to release the pressure from an associated hose, released, and then depressed again to facilitate removal of the hose from the coupler.

### BRIEF DESCRIPTION OF THE DRAWINGS

It is believed that certain embodiments will be better understood from the following description taken in conjunction with the accompanying drawings in which:

FIG. 1 is an isometric view depicting a push-button quick-connect coupler, in accordance with one embodiment;

FIG. 2A is a cross-sectional view taken along the line 2-2 in FIG. 1, with a stem shown in each of a retracted position and a venting position;

FIG. 2B is a cross-sectional view taken along the line 2-2 in FIG. 1, with a stem shown in each of a retracted position and an extended position; and

FIG. 3 is a cross-sectional view taken along the line 3-3 in FIG. 1.

### DETAILED DESCRIPTION

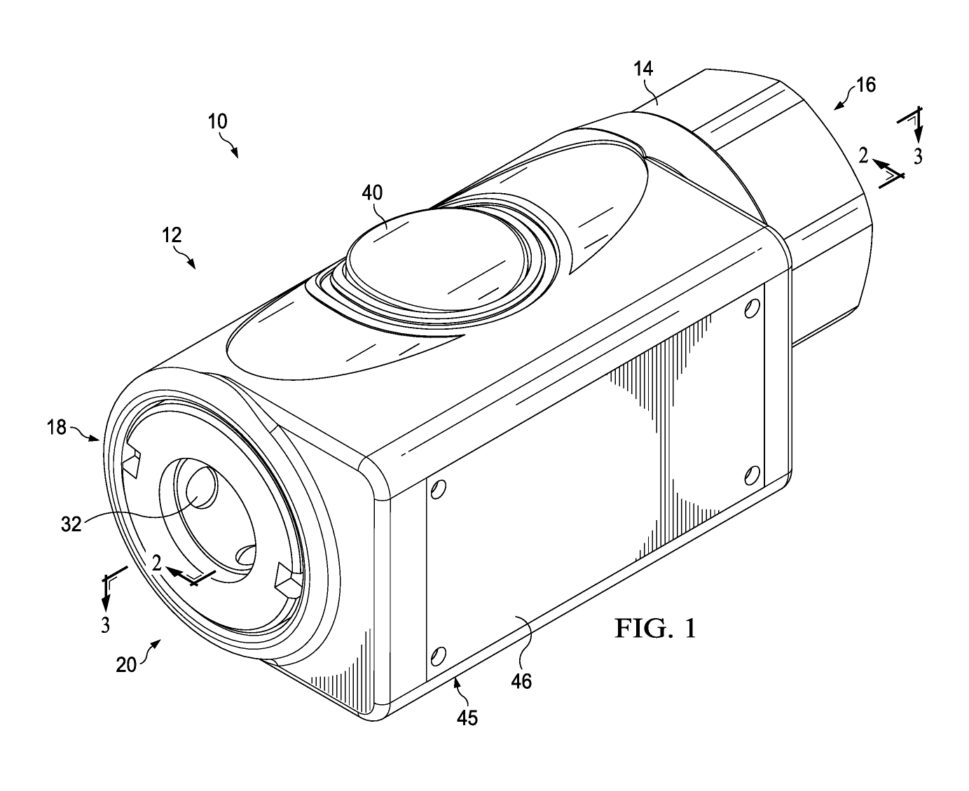

Embodiments are hereinafter described in detail in connection with the views and examples of FIGS. 1, 2A, 2B, and 3, wherein like numbers indicate the same or corresponding elements throughout the views. As illustrated in FIGS. 1, 2A, 2B, and 3, a push-button quick-connect coupler 10 (hereinafter “the coupler”) facilitates releasable coupling of a pneumatic device, such as a power tool, an air nozzle, a fluid storage tank, or a fluid hose (e.g., for filling the fluid storage tank), for example, to a fluid source such as an air compressor (not shown), a fluid storage tank (for dispensation of fluid therefrom) or another external source of pressurized air or other fluid. The coupler 10 can be provided upstream of the fluid source and downstream of the fluid powered tool.

Referring now to FIG. 1, the coupler 10 can include a body 12, a fitting 14 disposed at a rear end 16 of the coupler 10, and a coupling assembly 18 disposed at a front end 20 of the coupler 10. The fitting 14 can be configured to facilitate fluid coupling of the coupler 10 with a fluid source. The coupling assembly 18 can be configured to facilitate selective coupling and decoupling of a pneumatic device to the coupler 10.

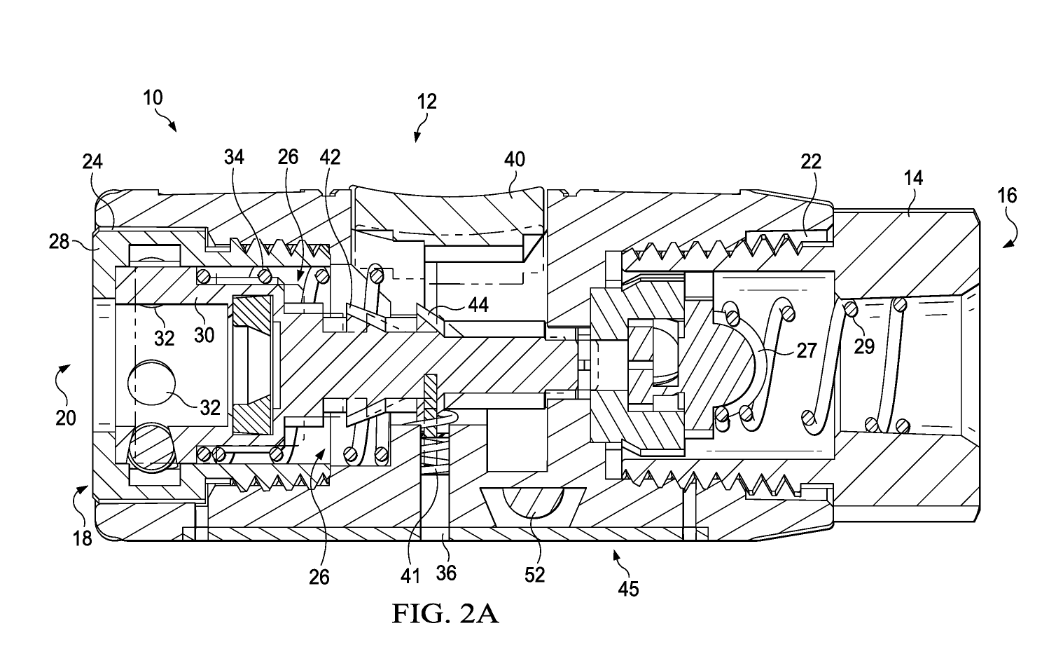

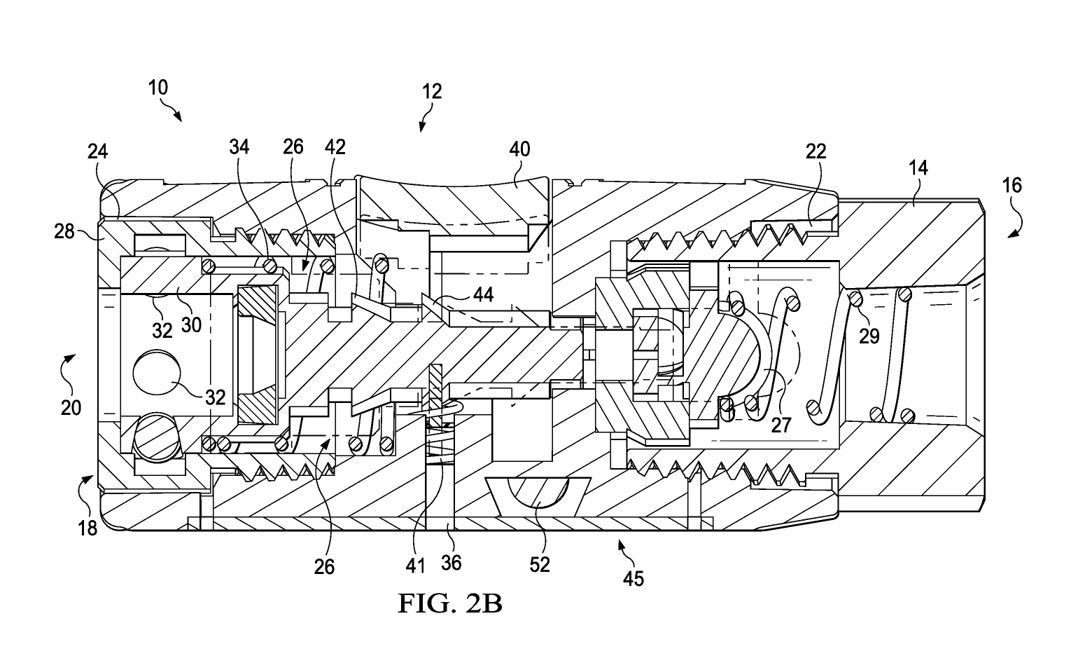

As illustrated in FIGS. 2A and 2B, the body 12 can define an input port 22, an output port 24, and a main passageway 26 that extends between the input port 22 and the output port 24 such that the input port 22 and the output port 24 are in fluid communication with each other via the main passageway 26. The fitting 14 can be disposed in the input port 22 and coupled with the rear end 16 of the body 12. A valve assembly 27 can be disposed in the input port 22 and can be slidable between a closed position (shown in solid lines) and an opened position (shown in dashed lines. The valve assembly 27 can be biased into the closed position by a spring 29. In one embodiment, the fitting 14 can be threadably coupled at one end with the body 12 and the other end can be configured for coupling with a hose or other output from the fluid source via a threaded connection or other suitable connection.

The coupling assembly 18 can be disposed in the output port 24 and can be coupled with the front end 20 of the body 12. The coupling assembly 18 can facilitate selective coupling and decoupling of a pneumatic device to the coupler 10. In one embodiment, as illustrated in FIGS. 2A and 2B, the coupling assembly 18 can be a quick connect coupling that includes an outer collar 28, a stem 30, and a plurality of floating balls 32. The outer collar 28 can be threadably coupled with the body 12 or coupled with the body 12 in any of a variety of suitable alternative arrangements, such as with a circlip, for example. The stem 30 can be slidably coupled with the outer collar 28 and slidable between a retracted position (shown in solid lines in FIGS. 2A and 2B), a venting position (shown in dashed lines in FIG. 2A) and an extended position (shown in dashed lines in FIG. 2B). The venting position can be between the retracted position and the extended position. When a fitting is not installed in the coupling assembly 18, the stem 30 can be in the retracted position and the valve assembly 27 can be in the closed position such that fluid is prevented from flowing through the main passageway 26. The stem 30 can be biased into the coupling position by a spring 34. It is to be appreciated that any of a variety of suitable alternative coupling assemblies are contemplated.

When a pneumatic device (e.g., a male quick-connect stud that is associated with a tool or other fluid powered device) (not shown) is installed in the coupling assembly 18, the pneumatic device can engage the stem 30 and can push the stem 30 into the extended position which pushes the valve assembly 27 into the opened position to allow pressurized fluid to flow from the fitting 14, through the main passageway 26 and to the pneumatic device. When the pneumatic device is installed in the coupling assembly 18 the floating balls 32 can interact with the pneumatic device to facilitate securement of the pneumatic device to the coupling assembly 18 such that extend into engagement with the outer collar 28 to urge a plurality of floating balls 32 radially inwardly.

Still referring to FIGS. 2A and 2B, the body 12 can define a venting port 36 that extends to the output port 24 such that the venting port 36 and the output port 24 are in fluid communication with each other. The coupler 10 can include a pushbutton 40 that is operably coupled with the stem 30 of the coupling assembly 18. The pushbutton 40 can be configured to be depressed (e.g., by a user) to facilitate releasing of the pressure within the coupler 10 through the venting port 36 as well as to facilitate decoupling of a pneumatic device from the coupling assembly 18. As illustrated in FIGS. 2A and 2B, the pushbutton 40 can be movable between a released position (shown in solid lines) and an actuated position (shown in dashed lines). The pushbutton 40 can be biased into the depressed position by a spring 41 such that when the pushbutton 40 is moved into the actuated position (e.g., by a user) and released, the pushbutton 40 automatically returns to the released position.

The stem 30 of the coupling assembly 18 can include a first annular member 42 and a second annular member 44 that selectively interact with the first annular member 42 and second annular member 44 to facilitate positioning of the stem 30 in each of the extended position and the venting position, respectively. For example, when the stem 30 is in the extended position (i.e., when a pneumatic device is inserted in the coupling assembly 18) with the pushbutton 40 in the released position, the first annular member 42 can engage the pushbutton 40 to hold the stem 30 in the extended position such that the valve assembly 27 is in the opened position and the plurality of floating balls 32 engage the pneumatic device to hold the pneumatic device in place. When the pushbutton 40 is depressed into the actuated position, the pushbutton 40 can disengage from the first annular member 42 enough to allow the stem 30 to slide towards the front end 20 (e.g., towards the venting position) via the spring 34 which facilitates movement of the valve assembly 27 into the closed position. Once the pushbutton 40 is disengaged from the first annular member 42, the spring 41 can urge the pushbutton 40 back to the released position such that the second annular member 44 then engages the pushbutton 40 to hold the stem 30 in the venting position. When the stem 30 is in the venting position, the pressurized air at the output port 24 is permitted to vent through the venting port 36 thereby depressurizing the coupler 10. When the pushbutton 40 is depressed again into the actuated position, the pushbutton 40 can disengage from the second annular member 44 which can allow the stem 30 to slide into the retracted position, thereby allowing decoupling the pneumatic device from the coupler 10. The pushbutton 40 therefore allows the coupler 10 to first be depressurized prior to decoupling of the pneumatic device to alleviate blowback at the output port 24 that is oftentimes experienced with conventional coupling arrangements. It is to be appreciated that although a pushbutton is described herein, any of a variety of suitable alternative actuators are contemplated, such as for example, a rotary actuator or a three position surface mounted switch.

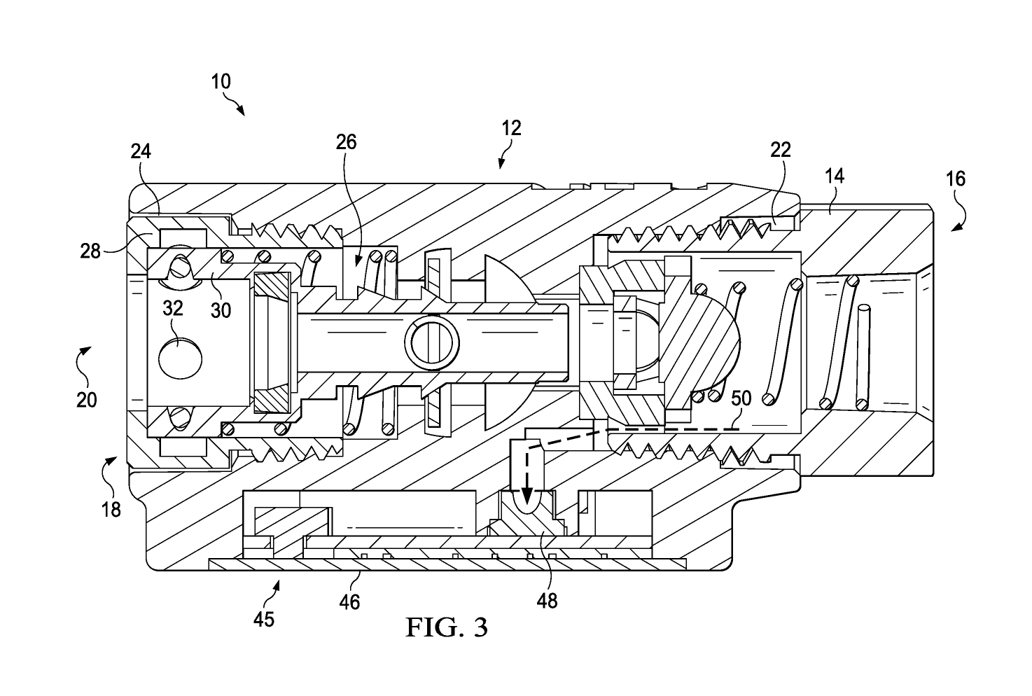

Referring now to FIGS. 1 and 3, the coupler 10 can include a pressure gauge 45 that is coupled with the body 12 of the coupler 10 and is in fluid communication with the input port 22. The pressure gauge 45 can include a digital display 46 (FIG. 1) that displays the internal pressure of the coupler 10 alphanumerically and can be configured to detect and display the internal pressure of the coupler 10. In such an embodiment, as illustrated in FIG. 3, the pressure gauge 45 can include a pressure transducer 48 that is mounted in the body 12 beneath the digital display 46 and is in electrical communication with the digital display 46. The body 12 can at least partially define a secondary passageway 50 that extends from the main passageway 26 and is separate from the main passageway 26. The secondary passageway 50 can be in fluid communication with the output port 24. The pressure transducer 48 can be disposed in the secondary passageway 50 such that the pressure transducer 48 is in fluid communication with the secondary passageway 50. The pressure transducer 48 can detect the air pressure in the secondary passageway 50 and can transmit air pressure data to a processor (not shown) that facilitates display of the air pressure on the digital display 46. It is to be appreciated that the pressure transducer 48 can be any of a variety of suitable electronic devices that are configured to detect an air pressure and transmit an electronic signal (e.g., a voltage signal) that represents the detected air pressure. It is also to be appreciated that the pressure gauge 45 can be an analog gauge having a mechanical pressure transducer that facilitates an analog display of the detected air pressure on the pressure gauge 45. It is further to be appreciated that a secondary passageway for detecting pressurized air (e.g., with a transducer) can alternatively be in fluid communication with the input port 22.

In one embodiment, the pressure gauge 45 can be powered by an onboard battery (e.g., 52 in FIGS. 2A and 2B). In other embodiments, the pressure gauge 45 can be powered by a solar panel, a super capacitor, or any of variety of other suitable onboard power supplies.

Referring again to FIGS. 2A and 2B, the venting port 36 and the pushbutton 40 can be disposed on opposite sides of the body 12 with the pressure gauge 45 disposed therebetween. As such, the coupler 10 can have an ergonomic layout that allows a user to grasp the coupler 10 with one hand with the user's thumb accessible to the pushbutton 40 and the user's other fingers provided on the opposite side of the coupler 10 (e.g., adjacent to the venting port 36). The coupler 10 can therefore be held such that the digital display 46 is not obstructed from view by the user's thumb and fingers. The user can also arrange his or her fingers away from the venting port 36 to prevent the vented pressurized air from being obstructed by the user's fingers.

It is to be appreciated that by detecting and displaying the pressure at the coupler 10, the pressure of an associated air tool can be more precisely controlled than conventional pressure gauges which can be located further downstream from the air tool than the coupler 10 (e.g., at the compressor). It is also to be appreciated that although the coupler 10 is described for use in a pneumatic system, the coupler 10 can be configured for use in any of a variety of suitable alternative fluid powered systems, such as a hydraulic system, for example. It is further to be appreciated that although a digital pressure gauge is described for the coupler 10, an analog pressure display is also contemplated.

One example of installing and using the coupler 10 with a pneumatic system will now be described. First, the fitting 14 of the coupler 10 can be attached to a pneumatic hose that is fed from a compressor. A pneumatic device (e.g., a male quick-connect stud) (not shown) is then inserted into the coupling assembly 18 which pushes the stem 30 into the extended position which opens the valve assembly 27 to allow the pressurized fluid to be delivered through the coupler 10 and to the pneumatic device. During use of the pneumatic device, the coupler 10 can display the pressure of the pressurized air on the pressure gauge 45 such that the user can make adjustments to the pressure as needed (e.g., via a pressure regulator at the compressor). When the user is finished with the pneumatic device, the user can depress the pushbutton 40 (e.g., into the actuated position). As described above, when the pushbutton 40 is initially depressed and released, the first annular member 42 is released and the stem 30 slides into the venting position where the second annular member 44 engages the pushbutton 40, thereby closing the valve assembly 27 and depressurizing the coupler 10 through the venting port 36 (which can be confirmed with the pressure gauge 45). The pushbutton 40 can then be depressed again to disengage the second annular member 44 from the pushbutton 40 and allow the stem 30 to slide to the retracted position to allow the pneumatic device to be removed from the coupling assembly 18.

The foregoing description of embodiments and examples of the disclosure has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate the principles of the disclosure and various embodiments as are suited to the particular use contemplated. In some embodiments, the drawings can be understood to be drawn to scale. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A coupler comprising:
a body that defines an input port, an output port, and a venting port that is in fluid communication with the output port, the body further defining a main passageway that extends between the input port and the output port;
a coupling assembly disposed at the output port and configured to facilitate selective attachment of a pneumatic device thereto;
a valve assembly associated with the input port and selectively movable between an opened position and a closed position, wherein when the valve assembly is in the closed position, the input port and the output port are fluidly isolated from each other;
a stem slidably coupled with the body and slidable between a retracted position, a venting position, and an extended position, the venting position being between the retracted position and the extended position, the stem being biased into the retracted position;
an actuator operably coupled with the stem and movable between a released position and an actuated position; and
a pressure gauge coupled with the body and in fluid communication with one of the input port and the output port, the pressure gauge being configured to detect and display a fluid pressure at said one of the input port and the output port, wherein:
sliding of the stem between the retracted position and the extended position facilitates movement of valve assembly between the closed position and the opened position, respectively;
when the stem is in the extended position, movement of the actuator into the actuated position facilitates sliding of the stem from the extended position to the venting position to facilitate venting of fluid in the main passageway through the venting port;
when the stem is in the venting position, movement of the actuator into the actuated position facilitates sliding of the stem from the venting position to the retracted position.

2. The coupler of claim 1 wherein the body further defines a secondary passageway that extends from the main passageway and is in fluid communication with the pressure gauge and said one of the output port and the input port.

3. The coupler of claim 2 wherein the pressure gauge comprises a pressure transducer disposed in the secondary passageway and configured to detect the fluid pressure in the secondary passageway.

4. The coupler of claim 1 wherein the pressure gauge comprises a digital display configured to display the fluid pressure at said one of the input port and the output port.

5. The coupler of claim 1 wherein the actuator comprises a pushbutton that is selectively depressible into the released position and the actuated position.

6. The coupler of claim 5 wherein the pushbutton is biased into the released position.

7. The coupler of claim 1 wherein the coupling assembly comprises a quick connect coupling.

8. The coupler of claim 1 wherein the actuator and the venting port are on opposing sides of the body.

9. The coupler of claim 8 wherein the pressure gauge is disposed between the actuator and the venting port.

10. A coupler comprising:
a body that defines an input port, an output port, and a venting port that is in fluid communication with the output port, the body further defining a main passageway that extends between the input port and the output port;
a stem slidably coupled with the body and slidable between a retracted position, a venting position, and an extended position, the venting position being between the retracted position and the extended position, the stem being biased into the retracted position;
an actuator operably coupled with the stem and movable between a released position and an actuated position; and
a pressure gauge coupled with the body and in fluid communication with one of the input port and the output port, the pressure gauge being configured to detect and display a fluid pressure at said one of the input port and the output port, wherein:
when the stem is in the extended position, movement of the actuator into the actuated position facilitates sliding of the stem from the extended position to the venting position to facilitate venting of fluid in the main passageway through the venting port; and
when the stem is in the venting position, movement of the actuator into the actuated position facilitates sliding of the stem from the venting position to the retracted position.

11. The coupler of claim 10 wherein the body further defines a secondary passageway that extends from the main passageway and is in fluid communication with the pressure gauge and said one of the output port and the input port.

12. The coupler of claim 11 wherein the pressure gauge comprises a pressure transducer disposed in the secondary passageway and configured to detect the fluid pressure in the secondary passageway.

13. The coupler of claim 10 wherein the pressure gauge comprises a digital display configured to display the fluid pressure at said one of the input port and the output port.

14. The coupler of claim 10 wherein the actuator comprises a pushbutton that is selectively depressible into the released position and the actuated position.

15. The coupler of claim 14 wherein the pushbutton is biased into the released position.

16. The coupler of claim 10 wherein the actuator and the venting port are on opposing sides of the body.

17. The coupler of claim 16 wherein the pressure gauge is disposed between the actuator and the venting port.

18. The coupler of claim 10 wherein the pressure gauge is in fluid communication with the output port.

19. A coupler comprising:
a body that defines an input port, an output port, and a venting port that is in fluid communication with the output port, the body further defining a main passageway and a secondary passageway, the main passageway extending between the input port and the output port, and the secondary passageway extending from the main passageway to the output port;
a coupling assembly disposed at the output port and configured to facilitate selective attachment of a pneumatic device thereto;
a valve assembly associated with the input port and selectively movable between an opened position and a closed position, wherein when the valve assembly is in the closed position, the input port and the output port are fluidly isolated from each other;
a stem slidably coupled with the body and slidable between a retracted position, a venting position, and an extended position, the venting position being between the retracted position and the extended position, the stem being biased into the retracted position;
a pushbutton operably coupled with the stem and movable between a released position and an actuated position;
a pressure gauge coupled with the body and in fluid communication with one of the input port and the output port, the pressure gauge comprising:
a pressure transducer disposed in the secondary passageway and configured to detect a fluid pressure in the secondary passageway; and
a digital display in electrical communication with the pressure transducer and configured to display the fluid pressure at the pressure transducer, wherein:
sliding of the stem between the retracted position and the extended position facilitates movement of valve assembly between the closed position and the opened position, respectively;
when the stem is in the extended position, movement of the pushbutton into the actuated position facilitates sliding of the stem from the extended position to the venting position to facilitate venting of fluid in the main passageway through the venting port;
when the stem is in the venting position, movement of the pushbutton into the actuated position facilitates sliding of the stem from the venting position to the retracted position;
the secondary passageway extends from the main passageway and is in fluid communication with the pressure gauge and said one of the output port and the input port; and
the pushbutton is biased into the released position.

20. The coupler of claim 19 wherein the pushbutton and the venting port are on opposing sides of the body, and the pressure gauge is disposed between the pushbutton and the venting port.
